(19) United States
(12) Patent Application Publication
(10) Pub. No.: US 2014/0009605 A1
(43) Pub. Date: Jan. 9, 2014

(54) Critical Temperature Indicator and Delivery Chain Confirmation and Method

(71) Applicant: T. Randall Lane, Lebanon, OH (US)

(72) Inventor: T. Randall Lane, Lebanon, OH (US)

(21) Appl. No.: 13/543,623

(22) Filed: Jul. 6, 2012

(51) Int. Cl. H04N 7/18

(52) U.S. Cl. 348/143; 348/E07.085

(57) ABSTRACT

A delivery chain confirmation system includes a temperature sensitive indicator which has a temperature sensitive area and provides a visual indication when exposed to temperatures which cross a predefined set threshold temperature and has indicia data thereon which corresponds to predetermined information data for a predetermined good and a communicating monitoring device having a processor and a camera operably connected thereto, delivery chain confirmation monitoring application software operably residing on the communicating monitoring device for obtaining indicia data and obtaining a visual image of the temperature sensitive indicator and storing the same as visual image data and for transmitting the indicia data and the visual image data to a remote processor.

### FIELD OF THE INVENTION

This invention relates to a device for indicating a critical temperature has been reached. More particularly, the invention relates to a temperature indicator with a delivery chain confirmation and method.

### PRIOR ART

Determining whether or not a particular good, such as a pharmaceutical or food, is exposed to a predetermined temperature may be of great importance. Devices can be attached to a good to determine whether or not the device, and consequently the good, is exposed to a predetermined temperature.

Currently, these devices employ electronics, paints and coatings that permanently change color once they have been exposed to a predetermined temperature. Problems with current technology coatings include the range of temperatures as well as whether the materials are permanent or reversible.

Bimetallic components have been used which change shape rapidly and significantly as a result of being exposed to a specified temperature. Other devices employ electronic sensors. Liquid crystals and leuco dyes have also been used for temperature indicators. Liquid crystals are used in precision applications, as their responses can be engineered to accurate temperatures, but their color range is limited by their principle of operation. Leuco dyes allow wider range of colors to be used, but their response temperatures are more difficult to set with accuracy. Other mechanical devices exist for indicating exposure to a predetermined freeze temperature. When the device is exposed to the predetermined freeze temperature, the mechanical components are actuated to cause a visual change.

Wether permanent or reversible, all current technology is deficient in regard to their chain of tracking the state of the article. Specifically, these devices may very well perform a transition to indicate a temperature crossing, but fail to provide an inexpensive mechanism and system for recording when the indicator has experienced a critical temperature.

While some of these devices provide critical temperature indicators, It is desired to improve the art and to reduce cost. Also, it is desired to have accurate critical temperature detection which is easily visually determined by a human operator whether a particular item has been exposed to a predetermined critical temperature and a delivery chain confirmation.

### SUMMARY OF INVENTION

It is an object to provide a critical temperature indicator.

It is another object to improve a delivery chain confirmation for temperature indicators.

It is another object to provide a an inexpensive system for a delivery chain confirmation for a temperature sensitive indicator.

Another object is to provide a method for tracking delivery confirmation.

Accordingly, one aspect of the invention is directed to a temperature indicator (such as a descending temperature indicator) that gives a visual sensitive indication when it has been exposed to temperatures crossing (e.g., below) its set threshold temperature. A preferred embodiment uses a label having indicia (such as information related to the goods) data printed thereon corresponding to a particular good information to which it is attached. A communicating monitoring device, such as a smart phone equipped with a camera, has a delivery chain confirmation monitoring application software thereon, provides for obtaining, e.g., reading, the information data and obtaining a visual of the temperature sensitive indicator thereon in a form of an image data and transmitting the indicia data and image data for purposes of providing a temperature chain verification. In this way, there is a verification of whether the indicator has been exposed to a critical temperature at a point of delivery time. This prevents a recipient from subsequently disputing that the goods were exposed to a critical temperature, in the case where the recipient received the goods in proper temperature compliance and then failed to maintain temperature thereby triggering the temperature indicator while in the recipient's possession.

A preferred embodiment of the device of the present invention will also have as part of the indicia, information as to whether the goods are valid or from a particular party, i.e, not grey market goods, can include product serial number, model number, lot number or other key product data or manufacturer data. The software can preferably be equipped to use such data as a precursor to reading the temperature indicator. For example, once proper data is obtained, this information can be used by the software for not only enabling reading temperature indicating material, such as temperature sensitive inks, but also the location of such inks on the the particular label. The software looks at a temperature sensitive area and determines if there has been a change which would indicate a critical temperature reached. The software makes a digital determination of the product is good or bad based on this. The device then records the date, time location of goods via location of the device (smart phone with location service turned on) at the time the image data is obtained.

This information data can be compiled into a PDF report which can be stored in multiple locations, including the device (phone), remotely located server (e.g., cloud computer) and e-mailed to a third party recipient. This permits a permanent file to be maintained. The invention permits multiple low costs temperature indicators to be used.

A method of the invention includes the steps of:
(a) providing a temperature sensitive indicator which indicates when it has been exposed to temperatures which cross a predefined set threshold temperature, wherein the label has indicia data corresponding to information data corresponding to at least one or more of a product serial number, model number, lot number;
(b) providing a communicating monitoring device which is equipped with a camera, wherein said device has a delivery chain confirmation monitoring application software for obtaining said indicia data and obtaining a visual image of the temperature sensitive indicator;
(c) operably disposing the device adjacent the indicator;
(d) activating the software in a manner to obtain and generate indicia data image data from the indicator. The method also includes transmitting the data to a remote computer for purposes of providing temperature chain verification.

### BRIEF DESCRIPTION OF DRAWINGS

FIG. 1 depicts a diagram of the invention of the instant invention.

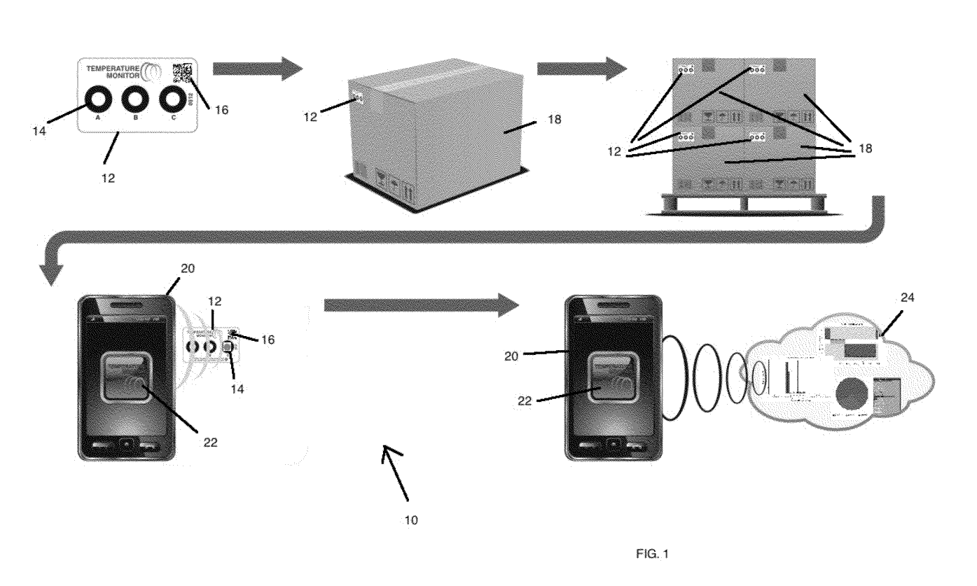

### DETAILED DESCRIPTION OF PREFERRED EMBODIMENTS

Referring now to the drawings, a temperature indicator with a delivery chain confirmation device and method is generally referred to by the numeral 10. The a temperature indicator with a delivery chain confirmation device and method 10 provides a visual indication record when a temperature sensitive indicator, such as a label 12, has been exposed to temperatures which cross a predefined set threshold temperature. In the instant embodiment, the label 12 can include one or more temperature sensitive ink spots 14. The label 12 can also include a indicia data 16 which can be a printed dot matrix, such as a QR code, which can include product serial number, model number, lot number or other key product data, manufacturer data, in addition to website, customer specific information, web links to frequently asked questions, and instructions for example.

The label indicia 16 printed on the label 12 corresponds to particular information data for specific good(s) 18 to which it can be attached. Goods 18 are typically packaged, and either warehoused or be shipped. The good(s) 18 are monitored during transit and warehouse storage.

A communicating monitoring device 20 is provided, such as a smart phone equipped with a camera. The communicating monitoring device 20 has a delivery chain confirmation monitoring application software 22 which provides for obtaining (e.g., via reading) information data from indicia data 16 and obtaining a visual image of the temperature sensitive indicator 16. The software 22 can generate image data from the visual image. The delivery chain confirmation monitoring application software 22 can transmit the information data from indicia data 16 as well as the image data for purposes of providing a temperature chain verification to a remote computer 24, such as a server or another computer. In this way, there is a verification of whether the indicator, label 12, has been exposed to a critical temperature at a point of delivery time.

This prevents a recipient from subsequently disputing that the goods were exposed to a critical temperature, in the case where the recipient received the goods in proper temperature compliance and then subsequent to receipt failed to maintain temperature thereby triggering the temperature indicator while in the recipient's possession.

As mentioned, the device 10 of the present invention also has as part of the indicia data 16, information as to whether the goods are valid or source from a particular party, i.e, the goods are not grey market goods, and can include product manufacturer information, serial number, model number, lot number or other key product data. The software 22 can preferably be equipped to use such data as a precursor to reading the temperature indicating ink spots 14. For example, once information data is obtained and is determined by proper by delivery chain confirmation monitoring application software 22, this information can be used by the delivery chain confirmation monitoring application software 22 for not only enabling reading temperature indicating material 14, such as temperature sensitive inks, but also the location of such inks on the the particular label 12. The delivery chain confirmation monitoring application software 22 will look at the temperature sensitive area and determine if there has been a change which would indicate a critical temperature reached. The delivery chain confirmation monitoring application software 22 will make a digital determination of the product is good or bad based on this. The device 20 then records the date, time location of goods via location of the device 20 (smart phone with location service turned on) at the time the image data is obtained.

This information data can be compiled into a PDF report which can be stored in multiple locations, including the device (phone), remotely located server (e.g., cloud computer) and/or e-mailed to a third party recipient. This permits a permanent file to be maintained. The invention permits multiple low costs temperature indicators to be used.

For example, label 12 can use a reversible ink, or preferably permanently transformed ink. In the case of a permanent ink, a translucent or clear container, such as a low MVTR film blister, can filled with a first temperature sensitive gel substance and a second temperature sensitive gel substance. The container with gel substances can be then sealed with a foil backing.

The gel substances will convert to liquid when it is exposed to temperatures below the set threshold temperature ad convert to liquid, a permanent color change occurs. The temperature sensitive gel substances can include a sol-gel which is a high concentration solution of a block copolymer of polyethylene oxide (PEO) and polypropylene oxide (PPO) in water. These solutions form very rigid thermo-reversible gels that can quickly transition from gel to liquid over a narrow temperature range of less than 1° C. The unique phenomena of the sol-gel formation, is explained by the properties of the PPO and PEO groups in the polymer. Also, additives can change the transition temperature based on their type and quantity. For example, addition of humectants reduces the transition temperature and addition of alcohols raises the transition temperature. Other configurations, color changes, methods will be apparent to one skilled in the art.

A method according to the invention includes the following steps. There is provided a temperature sensitive indicator which indicates when it has been exposed to temperatures which cross a predefined set threshold temperature, wherein the label has indicia corresponding to information data corresponding to at least one or more of a product serial number, model number, lot number or other key product data.

A communicating monitoring device is provided, such as a smart phone equipped with a camera which has a delivery chain confirmation monitoring application software for obtaining (e.g., via reading) the information data from indicia and obtaining a visual image of the temperature sensitive indicator. The device is operably placed adjacent the label and the software is activated in a manner to obtain and generate indicia data and image data from the visual image. The information data from indicia as well as the image data is transmitted to a remote computer for purposes of providing a temperature chain verification to a remote computer. The data can also be stored locally on the device.

The above described embodiment(s) is set forth by way of example and is not for the purpose of limiting the present invention. It will be readily apparent to those skilled in the art that obvious modifications, derivations and variations can be made to the embodiment without departing from the scope of the invention. Accordingly, the claims appended hereto should be read in their full scope including any such modifications, derivations and variations.

What is claimed is:

1. A delivery chain confirmation system, which includes:
a temperature sensitive indicator having a temperature sensitive area and provides a visual indication when exposed to temperatures which cross a predefined set threshold temperature and has indicia data thereon which corresponds to predetermined information data for a predetermined good; and
a communicating monitoring device having a processor and a camera operably connected thereto, delivery chain confirmation monitoring application software operably residing on said communicating monitoring device for obtaining indicia data and obtaining a visual image of said temperature sensitive indicator and at least temporarily storing the same as visual image data and for transmitting said indicia data and said visual image data to a remote processor.

2. The delivery chain confirmation system of claim 1, wherein said indicia data is printed on said indicator.

3. The delivery chain confirmation system of claim 1, wherein said communicating monitoring device is hand held.

4. The delivery chain confirmation system of claim 1, wherein said temperature sensitive indicator includes a label.

5. The delivery chain confirmation system of claim 4, wherein said indicia data is printed on said label.

6. The delivery chain confirmation system of claim 1, wherein said indicator includes at least one temperature sensitive ink spot.

7. The delivery chain confirmation system of claim 4, wherein said indicator includes at least one temperature sensitive ink spot.

8. The delivery chain confirmation system of claim 1, wherein said indicia data includes a dot matrix includes information corresponding to one of a product serial number, a model number, and a lot number.

9. The delivery chain confirmation system of claim 8, wherein said dot matrix includes one of a website data and customer information data.

10. The delivery chain confirmation system of claim 1, wherein said delivery chain confirmation monitoring application software analyzes said temperature sensitive area and generates digital critical temperature reached determination data if there has been a change which would indicate a critical temperature reached.

11. The delivery chain confirmation system of claim 10, wherein said delivery chain confirmation monitoring application software generates digital determination data corresponding to whether the predetermined product is good or bad based on said critical temperature reached determination.

12. The delivery chain confirmation system of claim 1, wherein said delivery chain confirmation monitoring application software records data corresponding to date, time and location of predetermined goods by using location of said communicating monitoring device.

13. The delivery chain confirmation system of claim 10, wherein said delivery chain confirmation monitoring application software compiles data into a PDF report.

14. The delivery chain confirmation system of claim 11, wherein said delivery chain confirmation monitoring application software compiles data into a PDF report.

15. The delivery chain confirmation system of claim 12, wherein said delivery chain confirmation monitoring application software compiles data into a PDF report.

16. The delivery chain confirmation system of claim 10, wherein said delivery chain confirmation monitoring application software records data corresponding to date, time and location of predetermined goods by using location of said communicating monitoring device.

17. The delivery chain confirmation system of claim 11, wherein said delivery chain confirmation monitoring application software records data corresponding to date, time and location of predetermined goods by using location of said communicating monitoring device.

18. A method for delivery chain confirmation, which includes the steps of:
(a) providing a temperature sensitive indicator which indicates when it has been exposed to temperatures which cross a predefined set threshold temperature, wherein said label has indicia data corresponding to information data corresponding to at least one or more of a product serial number, model number, lot number;
(b) providing a communicating monitoring device which is equipped with a camera, wherein said device has a delivery chain confirmation monitoring application software for obtaining said indicia data and obtaining a visual image of the temperature sensitive indicator;
(c) operably disposing said device adjacent the indicator;
(d) activating said software in a manner to obtain and generate indicia data image data from the indicator.

19. The method of claim 18, which includes the step of employing said delivery chain confirmation monitoring application software and recording data corresponding to date, time and location of predetermined goods by using location of said communicating monitoring device.

20. The method of claim 19, which includes transmitting said data to a remote computer for purposes of providing temperature chain verification.
